(19) United States
(12) Patent Application Publication
(10) Pub. No.: US 2002/0032730 A1
(43) Pub. Date: Mar. 14, 2002

(54) System and method for correlating data sessions

(76) Inventors: Rami Amit, Raanana (IL); Yuval Hertzog, Raanana (IL)

Correspondence Address: HELFGOTT & KARAS, P.C., 60th Floor, Empire State Building, New York, NY, 10118-0110, US

(21) Appl. No.: 09/733,637

(22) Filed: Dec. 8, 2000

Related U.S. Application Data
(63) Continuation-in-part of application No. 09/658,721, filed on Sep. 11, 2000.

(51) Int. Cl. G06F 15/16

(52) U.S. Cl. 709/204

(57) ABSTRACT

There are disclosed systems and methods for correlating a data collaboration session between at least two clients via a third client on a network. The method comprises providing a first, second and third client with a unique identifier and establishing a communication in an audio channel between the first and third clients The established communication in the audio channel is forwarded to the second client. The method further comprises signalling by the first client to the second client a request for a data collaboration session, responding to the signal by the first client by sending the unique identifier of the second client to the first client via the audio channel, associating the unique identifier of the second client with the communication and associating the identifier of the first client with the communication. The method further comprises transferring the associated identifiers of the first and second clients to a server configured for holding the data collaboration session.

### CROSS-REFERENCES TO RELATED APPLICATIONS

This application is a continuation-in-part of U.S. patent application Ser. No. 09/658,721 entitled System and Method For Correlating Data Sessions filed on Sep. 11, 2000, now pending said application being incorporated in its entirety by reference herein.

### FIELD OF THE INVENTION

The present invention relates generally to methods and apparatuses for interfacing with the internet.

### BACKGROUND OF THE INVENTION

Some websites facilitate a client (customer or surfer) visiting the website to simultaneously contact a human agent of the site by means of a two-way audio connection referred to as an “audio session”. The surfer or Client (customer) may avail himself of the possiibility of contacting a human agent, for example, when the surfer is unable to himself find the information he is seeking at the website. The audio session may be transmitted over a “Voice over Internet Protocol” (VOIP) connection, over a public switched telephone network (PSTN), or over a combination of the two. By its nature, however, the audio connection is not limited to carrying audio traffic.

At a typical call center, incoming calls are routed via the Private Branch Exchange (PBX) to an available agent by an “automatic call distribution” (ACD) center. In the audio session, the surfer may describe to the agent what information he is seeking at the site. The agent, in response, may send data to the surfer's computer terminal over an Internet connection and visa versa. This is referred to as a “data collaboration” or “co-browsing” session, collectively “data session”.

“Co-browsing” or “data collaboration” may, for example, be defined as both parties seeing the same pages loaded from the Internet as either party navigates through the Internet and/or seeing the same data in Internet based forms when either party enters data in a form. Thus, for example, the agent may show a customer around a web site (co-browsing session) while describing things (audio session) or assist orally (audio session) a customer to fill out a form (data collaboration session) which appears on both the customer's and the agent's screen. Both parties see the data which either party enters.

Data collaboration may be routed through a Data Collaboration System or Server (DCS) which is responsible for sending the same information to the browser of the client and the agent, whether this is data or Internet pages. This is typically through a data collaboration server.

The data session must be correlated with the audio session in order to ensure that the data session occurs between the computers, typically the browser applications, of the parties that are communicating in the audio session.

One method of correlating an audio and a data session involves a data collaboration server (DCS) that is directly connected to the PBX/ACD of a calIcenter via a computer telephony/Integration (CTI) interface.

The connection is used to provide the DCS with information relating to the audio session, for example, to which telephone in the call center the call has been routed by the ACD of the callcenter. This may be correlated to the identity of the agent who is engaged in the audio call and hence the identity of the agent's computer, typically an identifier of an application within the computer (such as a plug-in on a browser). Since the client or customer initiated the call, the identity of his application is already associated with the audio call. This, therefore, enables the DCS to send information to both the browser of the client and the agent, which are associated with the audio call, simultaneously.

A CTI interface is difficult to install however, in many circumstances, for example, where the call center is situated far from the (centralized) DC server where the cost and logistics of such a link become prohibitive. Similarly, security considerations sometimes make it favorable to not link the PBX/ACD and the DCS as the DCS is connected to the Internet. Furthermore, certain types of PBX such as a Small Office Home Office (SOHO) are not connectable to a CT/I interface. Thus, the contemporary art falls short as in the above circumstances it does not allow a call-center to be enabled for co-browsing.

Also, when the CTI link to the PBX/ACD is not present an agent wishing to transfer an incoming audio call with coordinated data collaboration, perhaps to a more suitable agent, may transfer the audio connection but there are no means for the second receiving agent to identify his browser to the DCS and so cobrowse with the client. Similarly, an agent wishing to conference an audio call from a client with a second (or third etc) agent would be able to accomplish the audio conference through the PBX of the callcenter but conferencing the Data Collaboration three (or more) ways would not be possible as the second (or third etc) agent would not be able to identify his browser to the DCS. Thus, the contemporary art falls short as in the above circumstances of forwarding or conferencing the audio call cobrowsing is not possible.

### SUMMARY OF THE INVENTION

The present invention improves on the contemporary art by providing systems and methods for initiating, perpetuating and coordinating audio calls via an audio channel (where the audio channel is not limited to conveying audio only) with data collaboration sessions via a data channel over a network, such as the Internet without the need for a link between the (Automatic Call Distributor) ACD of an agent's callcenter and the DC server. This is accomplished by is providing a reading application for the Client (customer or surfer) and the agent in the audio channel which conveys the audio call (hereafter “audio channel”) which facilitates the agent (call recipient) to send information as to the identity of his computer via the audio connection which is conveyed to the DC server, thus associating both the client and agent's computers, associated with that particular audio call, for cobrowsing.

The present invention is applicable to computer networks both Local (LAN) and Wide Area Networks (WAN) including those that employ Internet Protocol (IP) and/or a graphical user interface. Exemplary embodiments of the invention will be described with respect to the Internet and the World Wide Web.

The invention provides a system and method for correlating an audio session with a data session in a Data Collaboration Server (DCS) or matching an identifier of an application running on a browser of an agent through an Application Program Interface (API) selected by an ACD to receive an audio call from a clients application running on a browser to the browser of that sending client, that does not involve of a communication link between the data collaboration system and the ACD of the callcenter.

In one embodiment, the agent at the call center selected by the ACD to receive an audio call identifies his computer during the audio session to the client's computer by means of a Unique Identifier (UID) such as, for example, a unique sequence of dual-tone multiple-frequency (DTMF) signals which can be keyed into the telephone keypad or the like via the audio channel and later read by the reading application, for example contained in a browser plug-in of the client's computer and forwarded to the DCS along with the identifier of the client's computer for cobrowsing.

In another embodiment, the audio channel contains an automatic speech recognizer (ASR) as a reading application attached to a Computer Telephony Integration (CTI) Server which identifies the voice of the agent or an answering call-sign of his and conveys an agent identifier associated with the voice to a database connected to the DCS which contains the UID or unique identifier of the computer or browser/browser application of a particular agent. The UID of the client associated with the audio call is also sent to the DCS, either by the CTI server or by another route thus enabling matching of identifiers for cobrowsing. The CTI may also read the unique identifier keyed in by the agent as is described in the above embodiment in respect of the browser.

In a further embodiment, the agent receiving a call on the audio channel may transfer the audio call to a second agent via the PBX whereupon that second agent keys in his UID to identify himself as a new cobrowser in the data session. The first agent may stay in the data session, resulting in a three way data session or may be automatically or manually removed from the data session when the additional UID is inputted. This process can be repeated for many more agents. In fact, any agent who is linked to the audio channel may input a UID of another agent or himself in order to have the additional agent or himself participate in the data session.

The present invention is directed to systems and methods for correlating a data collaboration session between at least two clients via a third client on a network.

The method comprises providing a first, second and third client with a unique identifier and establishing a communication in an audio channel between the first and third clients. Further, the established communication in the audio channel is forwarded to the second client. The method further comprises signalling by the first client to the second client a request for a data collaboration session, responding to the signal by the first client by sending the unique identifier of the second client to the first client via the audio channel, associating the unique identifier of the second client with the communication and associating the identifier of the first client with the communication. The method further comprises transferring the associated identifiers of the first and second clients to a server configured for holding the data collaboration session. Furthermore the signalling step is a voice request or a series of tones. The method is further directed to signalling utilizing a series of tones. Furthermore, the method is directed to responding to the signal of the first client by sending the unique identifier of the second client to the first client by sending a unique series of DTMF tones. The method is further directed to responding utilizing a voice response.

Further, when the established communication is forwarded to the second client the third client may be retained as a participant of the audio channel communication. Furthermore, responding to the signal by the first client may include additionally sending the unique identifier of the third client via the audio channel.

### BRIEF DESCRIPTION OF THE DRAWINGS

The present invention will be understood and appreciated more fully from the following detailed description taken in conjunction with the appended drawings where like numerals and/or characters indicate corresponding or like components in the drawings:

FIG. 1 is an illustration of a system in accordance with a first embodiment of the present invention;

FIG. 2 is a flow chart diagram showing the operation of the invention in accordance with the embodiment of FIG. 1;

FIG. 3 is an illustration of a system in accordance with a second embodiment of the present invention;

FIG. 4 is a flow chart diagram illustrating a third embodiment of the present invention.

### DETAILED DESCRIPTION OF THE PRESENT INVENTION

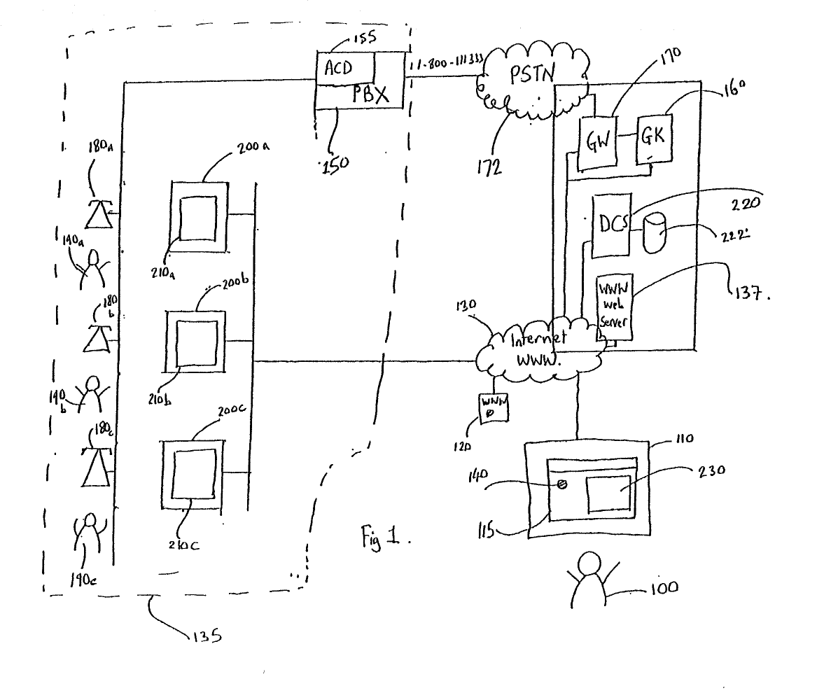

FIG. 1 illustrates a first embodiment of the present invention as shown by an exemplary architecture. A Client 100, typically a customer (or surfer) is connected, by a computer terminal 110 or the like via a browser 115 or other equivalent application-program interface (represented by a screen view), via an application to a webserver containing a website 120. The browser 115 is connected via a network such as the the internet 130. The website 120 sends (or pushes) webcontent to the application within the browser 115 of the client 100 which is, for example, identified by a Unique Identifier (UID) 132.

Website 120 is configured to allow Client 100 to call a call center 135 associated with website 120 by, for example, downloading the Surf & Call® Plug-in Voice Over IP (VOIP) client solution manufactured by VocalTec Communications of Herzlia, Israel to browser 115 of client 100 along with webcontent 130, from, for example, www .web server 137.

The Surf & Call® Plug-in (S&C) may be represented by a screen icon button 140 on computer terminal 110. When button 140 is pressed, an audio call is made from browser 115 via, for example, a VOIP signalling protocol to a Private Branch Exchange (PBX) 150, of callcenter 135 via a Gatekeeper (GK) 160 and a Gateway (GW) 170 manufactured, for example, by VocalTec® Communications of Herzelia, Israel utilizing the Public Switched Telephony Network (PSTN) 172 to contact PBX 150. PBX 150 contains an Automatic Call Distributor (ACD) 155 for distributing the call according to pre-programmed preferences to telephones 180a,180b or 180c or their equivalent used by, for example, call center agents 190a,190b or 190c respectively. The agent (and associated computer) may also be termed a client. The entire network connecting the audio call from (and including) the browser 115 up until it reaches PBX 150 may be collectively termed the Audio Channel. This may be extended to include the PBX 150 where the ACD 155 is separate therefrom. As described further hereinbelow, the initial audio call from the Client 100 to the callcenter 135 is associated with the browser or browser application Unique Identifier (UID) of the Client 100 since it originated therefrom.

Agents 190a,190b, 190c similarly have computers 200a, 200b, 200c or their equivalent with browsers or their equivalent 210a, 210b, 210c, respectively. The browsers 210 of agents 190 which are similarly to browsers 115 equipped with a cobrowsing application also have UID's similar to those of browser 115 of Client 100. In order to coordinate the browser 210 of the agent 190 who received the audio call from the Client 100, with the browser 115 of the Client 100 who made the audio call for cobrowsing purposes a Data Collaboration Server (DCS) 220 must receive the UID's of the respective Client and Agent browser's co-browsing application which are connected in the audio call so that it recognizes, identifies and matches the signals in order to connect browsers 115 and 210 in a cosurfing conversation using a cobrowsing application as described further hereinbelow.

The DCS 220 may then convey the web pages that either one of the Client or Agent browsers 115, 210 “sees”, in a data collaboration or cobrowsing session to the other cobrowsing party. This is achieved by a data collaboration (application) applet in the browser of client and agent 115, 210 which is part of the Surf & Call Network Services^{TM} software known as the Data Collaboration (or DC) component 230 which sends or “pushes” the web content or data to the DCS 220 for forwarding to the other browser. The sending or “pushing” functionality is achieved by a routing application in the browser known as a “Traffic Cop” designed to send the data to DCS 220. These applications are all preferebly downloaded from www. webserver 137. DCS 220 preferably contains a database 222 containing the browser UID's associated with each agent 190 which may be inputted by the agent 190, for example, via a data link or Internet 130 when he logs on initially, for example each morning. The agent 190 would type in his name or an ID associated with his name (hereafter “agent ID”) and the UID of the browser 210 (application) which he is using. Thus, an agent may change his position and sit at a different computer 200 each day and the callcenter can correlate him with a particular browser 210.

Synchronisation of browser UID's is achieved when the agent 190 receives the audio call via his telephone 180. The Client 100 then requests the agent 190 to cobrowse. The agent then types in his browsers UID or his own agent ID on the audio channel 192 using the telephone keypad of his telephone 180, preferably using dual-tone multiple-frequency (DTMF) signals. DTMF signals are the additive combination of two constant amplitude sinusoidal components which convey the UID or agent ID. The Surf & Call® browser plug-in application reads the DTMF signals preferably after conversion by GK 160 to a data format via a reading application thus capturing the UID of browser 210 or the agent ID. The Surf & Call R of the Client 100 browser 115 then conveys the UID of the agent browser 210 together with the UID of the Client browser 115 to the DC component 230 which pushes or sends them to the DCS 220. Cobrowsing can now occur as the two browsers are associated via the DCS 220. Cobrowsing actually occurs when the browsers 210 and 115 are connected to DCS 220 which can occur at any time. It should be noted that if agent 190 sends his agent ID, DCS 220 retrieves his (browser) UID from database 222. It should be noted that the UID or agent ID could be deciphered anywhere on the audio channel by suitable means and not necessarily in Client Browser 115, and then sent to DCS 220.

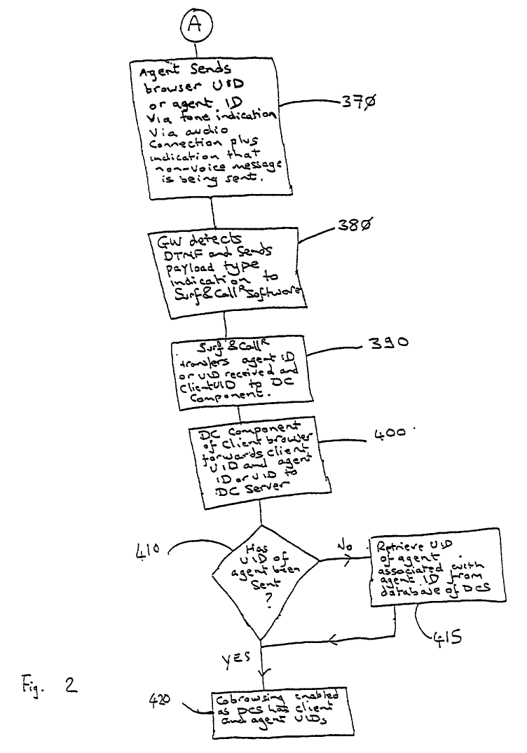

FIG. 2 is a flow chart of the exemplary steps in the process of coordinating audio and data sessions between a Client 100 and an Agent 190 at a callcenter 135. At step 300 agent 190 inputs agent ID and UID (of browser) to database 222 of DCS 220 via his computer 200, preferably via the Internet. At step 305 the Client 100 directs his browser (surfs) to the call-center enabled web page 120 and at step 310 downloads a customer workstation comprising the Surf & Call Network ServicesR software produced by VocalTec Communications of Herzlia Israel including the Surf &Call® plugin for IP protocol PC to Phone audio calls to the callcenter 135, the Data Collaboration (DC) applet 230, a “Traffic Cop” routing interface (step 310) and a Graphical User Interface (GUI).

At step 320, Client 100 activates Surf & Call® typically by clicking the icon to initiate an IP protocol audio call to the callcenter 135. A t step 330, Gatekeeper 160 receives the request to connect to a PSTN number, for example a DNIS such as 1-800-111 333 of PBX 150 of callcenter 135. At step 340 GK 160 sends an authorization t o the Surf & Call® software giving authorization for the call and for routing it via Gateway 170. At step 350 the call is routed to PBX 150 within callcenter 135 and ACD 155 within PBX 150 selects a telephone, say 180a with an agent 190a to receive the call. At step 360 Client 100 requests to cobrowse with agent 190a and at step 370 Agent 190a sends his browser UID or agent ID, preferably using DTMF tones keyed in to his telephone 180a via the audio channel 192.

At step 380 GW 170 detects these tones sending a payload type indication of Agent 190a's browser UID or the agent ID to Surf & Call® plugin in Browser 115 of Client 100. Surf & Call within browser 115 then transfers the browser UID of the Client 100 and the browser UID or agent ID of the agent 190a to the Data Collaboration component 230 of VocalTec Surf & Call® Network software at step 390. At step 400 the DC component forwards the client UID and the agent ID or UID to DCS 220 to enable cobrowsing. At step 410 if the agent UID has been sent, cobrowsing is enabled at step 420 and if not, the UID of agent browser 210 is retrieved from database 222 (FIGS. 1,2) by correlating with a gent ID supplied to DCS 220 (step 415) and then cobrowsing is enabled at step 420 as browser UDs of Client 100 and agent 190a are associated in DCS 220. Cobrowsing can occur when browsers 115, 210 connect to DCS 220 which can occur at any time.

It should be noted, as stated above and shown in FIG. 2 that agent 190 may key in to his telephone keypad the UID of his browser 210 directly instead of his agent ID when the audio call arrives from client 100, thus removing the need for initially inputting agent ID and associated UID (step 300) and later correlation of the agent ID with his UID in DCS 220.

It should also be noted that the web-page 120 may be enabled with a frequency generating code which causes the browser 115 (or browser application) to generate frequencies when the Surf & Call® button 140 is activated by Client 100 and the audio call is connected to telephone 180a. of agent 190a. Thus, agent 190a hears a recognition signal or “tune” which he recognizes is an audio call requesting a co-browsing session. He then keys in his browser UID or agent ID to telephone 180a together with an indication to browser 115 to stop sending the tune.

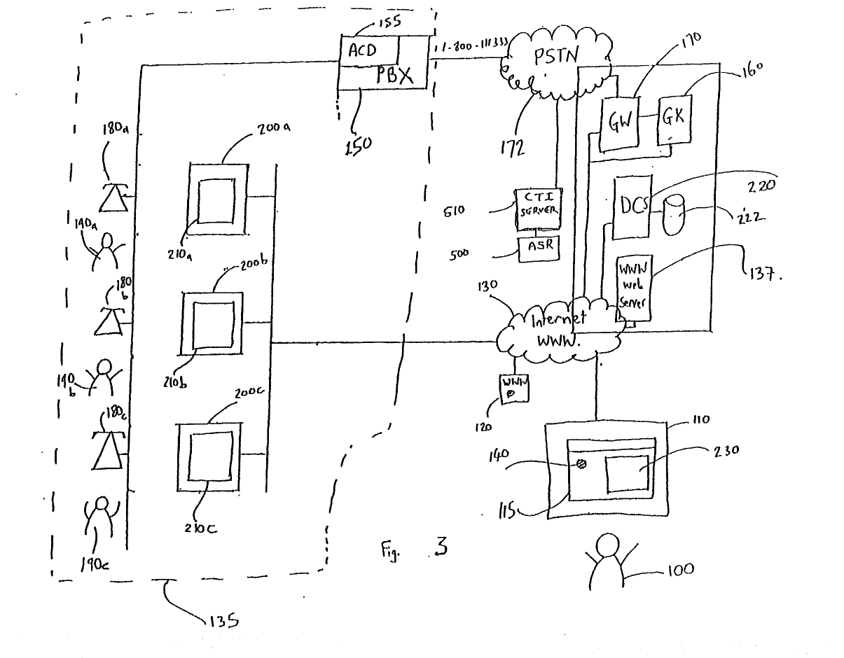

Reference is now made to FIG. 3 which illustrates a second embodiment of the present invention in which similar components to those in previous figures have the same reference numerals. In this embodiment an Automatic Speech Recognition module (ASR) 500 is attached to the audio channel 192, preferebly via a Computer Telephony Integration (CTI) server 510. ASR 500 or CTI server 510 is preferably connected to a database (not shown) attached proximate to it.

ASR 500 is “trained” to recognize the voice of each agent by the agent accessing it, preferably using his telephone 180 or via other means and speaking and contemporaneously inputting his agent ID or UID whilst connected. ASR 500 may also be trained to recognize a catchword or slogan uttered by anyone. The ASR 500 will then recognize the agent 190's voice when he answers the telephone 180 and the request to cobrowse is automatically registered with DCS 220 by virtue of the call being made. The ASR 500 then forwards the agent ID corresponding to the voice to database 222 where the agent browser UID is matched to it—completing the cobrowsing association in DCS 220. The agent can also use a catchphrase or word to indicate himself (word recognition).

It should be noted that CTI server 510 (FIG. 2) may also read the agent ID or UID inputted by agent 190 to the keypad of his telephone 180 in a similar way to Surf & Call® with browser 115 as described hereinabove in relation to the first embodiment (FIG. 1).

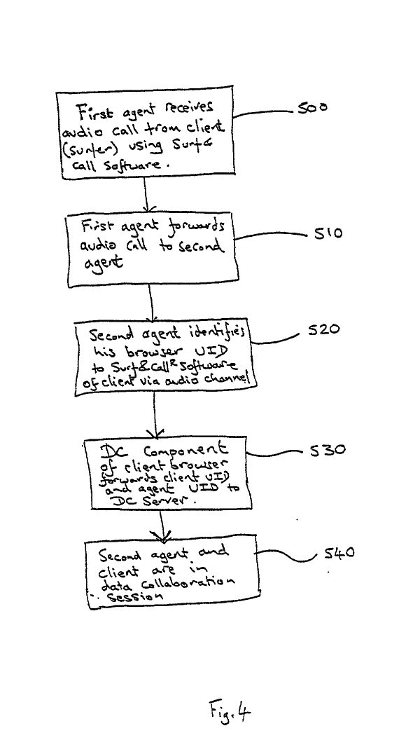

Reference is now further made to FIG. 4 which is a flow chart illustration of a third embodiment of the present invention. Reference is further made to FIG. 1 and FIG. 3.

At step 500 a first agent 190a receives an audio call from client 100 as described hereinabove. First agent 190a then forwards or conferences the audio call to a second agent 190b at step 510b. At step 520 second agent 190b identifies to the Surf & Call® software his UID via the audio channel, preferably using DTMF tones as described hereinabove. At step 530, the DC component of the browser 115 of client 100 forwards the UID of client 100 together with the UID of agent 190b to DCS 220 to enable cobrowsing. At step 540, the second agent 190b and the client 100 are in a data collaboration session. It should be noted that first agent 190a may before or after forwarding the audio call to agent 190b input his UID so that the Surf & Call R of client 100 captures it and includes him in the data collaboration session by forwarding his UID along with the others to DCS 220. Thus, a three (or more) way data collaboration session may be achieved. It should also be noted that upon receiving the audio call from client 100, agent 190a may, if he knows the UID of agent 190b input the UID of agent 190b himself in order to initiate agent 190b in a data collaboration session with client 100.

It should be noted that transmission of the UID or ID of agent 190 may be achieved by many means not limited to audio signals, for example optical and digital means, via the audio channel.

It is appreciated that one or more of the steps of any of the methods described herein may be omitted or carried out in a different order than that shown, without departing from the true spirit and scope of the invention.

While the present invention as disclosed herein may or may not have been described with reference to specific hardware or software, the present invention has been described in a manner sufficient to enable persons of ordinary skill in the art to readily adapt commercially available hardware and software as may be needed to reduce any of the embodiments of the present invention to practice without undue experimentation and using conventional techniques.

While the present invention has been described with reference one or more specific embodiments, the description is intended to be illustrative of the invention as a whole and is not to be construed as limiting the invention to the embodiments shown. It is appreciated that various modifications may occur to those skilled in the art, while not specifically shown herein, are nevertheless within the true spirit and scope of the invention.

What is claimed is:

1. A method for correlating a data collaboration session between at least two clients via a third client on a network, the method comprising:
providing each of said first second and third clients with a unique identifier;
establishing at least one communication in an audio channel between said first and third clients;
forwarding said established at least one communication in said audio channel to said second client;
signalling by said first client to said second client at least one request for at least one data collaboration session;
responding to said signal by said first client by sending via said audio channel said unique identifier of said second client to said first client;
associating said unique identifier of said second client with said at least one communication;
associating said identifier of said first client with said at least one communication;
transferring said associated identifiers of said first and second clients to a server configured for holding said data collaboration session.

2. The method of claim 1 wherein said step of signalling comprises a voice request.

3. The method of claim 1 wherein said step of signalling comprises a series of tones.

4. The method of claim 1 wherein said step of responding comprises sending a unique series of DTMF tones.

5. The method of clam I wherein said step of responding comprises a voice response.

6. The method of claim 1 where said step of forwarding further includes retaining said communication between said first and third clients in said audio channel;

7. The method of claim 6 wherein said step of responding further comprises sending said unique identifier of said third client via said audio channel.
